(19) United States
(12) Patent Application Publication
(10) Pub. No.: US 2012/0147583 A1
(43) Pub. Date: Jun. 14, 2012

(54) EXTENDABLE LIGHT BOX

(76) Inventor: Peng-Cheng LAI, Los Altos, CA (US)

(21) Appl. No.: 12/964,211

(22) Filed: Dec. 9, 2010

(51) Int. Cl. G03B 15/02

(52) U.S. Cl. 362/11

(57) ABSTRACT

An extendable light box of this invention, which can be collapsed as an enclosure-type light box or extended to a wide-open type of photography system, comprises a photography platform and left, right, back and top lamp-housing. The left, right and back lamp-housing are connected to the photography platform with a sliding/extending mechanism, such as a slide guide or shearing-type extending unit. The top lamp-housing stands on the back lamp-housing and connected with a rotating mechanism, such as a joint. The photography platform and the back lamp-housing can be combined into a unit. The photography platform can also be a lamp-housing, or/and with a rotating turntable embedded. At least one horizontal and vertical joint are configured on the sliding/extending mechanism for horizontal rotating and vertical folding. Therefore, those lamp-housings can be moved away from the photography platform or even rotate and fold to the height and direction for lighting.

### BACKGROUND OF THE INVENTION

1. Field of the Invention

The present invention relates to a light box and particularly to an extendable light box, which can be collapsed as an enclosure-type light box or expanded as a wide-open type of photography system.

2. Description of the Prior Art

A normal light box is in enclosure type and consists of a photography platform, left lamphousing, right lamphousing, back lamphousing and top lamphousing. Positions of the related lamphousings are fixed. The enclosure-type light box gets less affection from lighting environment in photographing to create a better image quality. However, the size of a photographed object is limited by its photographing room.

On the other hand, a larger photographed object can not fit the small photographing room of an enclosure-type light box. Instead, the larger photographed object is placed on an open photography platform in photographing, and surrounded by lamps or lamphousings. However, the wide-open type of photography system is seriously affected by lighting environment.

An extendable light box is disclosed, which can be collapsed as an enclosure-type light box or expanded as a wide-open type of photography system. Therefore the extendable light box can be used to shoot different sizes of photographed objects for the cost and storage space saving.

### SUMMARY OF THE INVENTION

According to an aspect of this invention, an extendable light box is proposed, which can be collapsed as an enclosure-type light box or expanded as a wide-open type of photography system.

According to an aspect of this invention, an extendable light box comprises a left, right and back lamphousing and a photography platform, and these lamphousings are respectively connected to the photography platform with a sliding/an extending mechanism. Using the sliding/extending mechanisms, the lamphousings can slide away from the photography platform to expand as a wide-open type of photography system. A top lamphousing is also connected to top of the back lamphousing with a rotation mechanism.

According to an aspect of this invention, the photography platform and the back lamphousing can be combined as a unit. The left and right lamphousing are connected to the photography platform with sliding/extending mechanisms, and the top lamphousing is connected to the back lamphousing with a rotation mechanism. Especially, the photography platform and back lamphousing are combined in a perpendicular or round form.

According to one embodiment of this invention, the sliding/extending mechanisms of an extendable light box connecting the photography platform and left, right and back lamphousings can be implemented by slide guides or shearing-type extending units. The slide guide or shearing-type extending unit is equipped with at least one horizontal and/or vertical joint and can be horizontally rotated and/or vertically folded. The rotation mechanism connecting the back and top lamphousing is also implemented by a vertical joint. As a result, the locations and the directions of the left, right, back and top lamphousing can be adjusted to positions and orientation for lighting in photographing.

The photography platform can also be designed as a lamphousing or embedded a turntable according to one embodiment of this invention.

Other advantages of the present invention will become apparent from the following description taken in conjunction with the accompanying drawings, which are set forth by way of illustration and example, to certainly embody the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a diagram of one embodiment according to this invention to schematically show an extendable light box, which is collapsed as an enclosure-type light box;

FIG. 2 is a diagram of one embodiment according to this invention to schematically show an extendable light box, which is expanded as a wide-open type of light box;

FIG. 3 is a diagram to schematically show the structure of a slide guide of an extendable light box according to one embodiment of this invention;

FIG. 4a and FIG. 4b are diagrams to respectively and schematically show the structures of dual and single shearing-type extending unit of an extendable light box according to one embodiment of this invention;

FIG. 5 is a diagram to schematically show the structure of a horizontal joint disposed on the sliding/extending mechanism of an extendable light box according to one embodiment of this invention;

FIG. 6 is a diagram to schematically show the structure of a vertical joint disposed on the sliding/extending mechanism of an extendable light box according to one embodiment of this invention;

FIG. 7 is a diagram to schematically show the structure of slide guide of an extendable light box according to one embodiment of this invention for illustrating the integration of the sliding, horizontal rotation and vertical folding mechanism;

FIG. 8 is a diagram to schematically show the status of expanding the left and right lamphousing of an extendable light box according to one embodiment of this invention;

FIG. 9 is a diagram to schematically show the status of expanding the back and top lamphousing of an extendable light box according to one embodiment of this invention;

FIG. 10 is a diagram to schematically show an extendable light box according to one embodiment of this invention, similar with the embodiment shown as FIG. 2, but the photography platform is designed as a lamphousing;

FIG. 11 is a diagram to schematically show an extendable light box according to one embodiment of this invention, similar with the embodiment shown as FIG. 2, but the photography platform is embedded with a turntable;

FIG. 12 is a diagram to schematically show an extendable light box according to one embodiment of this invention, similar with the embodiment shown as FIG. 2, but the photography platform designed as a lamphousing and embedded by a turntable;

FIG. 13 is a diagram to schematically show an extendable light box according to one embodiment of this invention, similar with the embodiment shown as FIG. 12, but the photography platform and back lamphousing are perpendicularly combined as one unit; and

FIG. 14 is a diagram to schematically show an extendable light box according to one embodiment of this invention, similar with the embodiment shown as FIG. 13, but the photography platform and back lamphousing are roundly combined as one unit.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

This invention discloses an extendable light box, which can be collapsed as an enclosure-type light box or expanded as a wide-open type of photography system. The extendable light box comprises a photography platform, a left lamphousing, a right lamphousing, a back lamphousing and a top lamphousing, and the left, right and back lamphousing are connected to the photography platform with sliding/extending mechanisms respectively. At least one horizontal and/or vertical joint is configured on the sliding/extending mechanism for rotating and/or folding, so the lamphousings can be moved away from the photography platform and adjusted to the locations and directions for lighting. A top lamphousing is connected to the top of the back lamphousing with a rotation mechanism (such as a joint), and a camera housing is arranged on the top lamphousing.

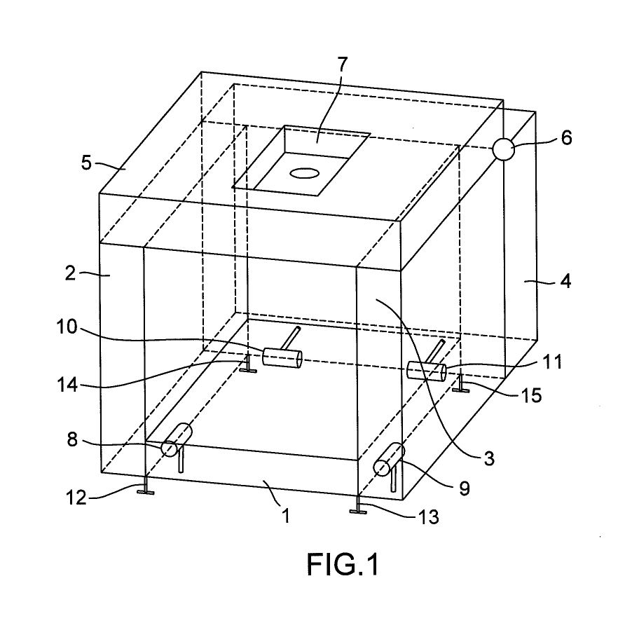

FIG. 1 shows the collapsed status of an extendable light box according to one embodiment of this invention, which is shown as an enclosure type of photography light box. A photography platform 1 is surrounded by a left lamphousing 2, right lamphousing 3 and back lamphousing 4. A top lamphousing 5 is connected to the back lamphousing 4 with a vertical joint 6 and a camera housing 7 is arranged on the top lamphousing 5. Vertical joints 8, 9, 10 and 11 are respectively arranged under the left lamphousing 2, right lamphousing 3 and back lamphousing 5 for tilting the lamphousings 2, 3 and 4. The lamphousings 2, 3 and 4 can be moved away from the photography platform 1. Adjuster pads 12, 13, 14 and 15 are configured under the light box for supporting the whole system.

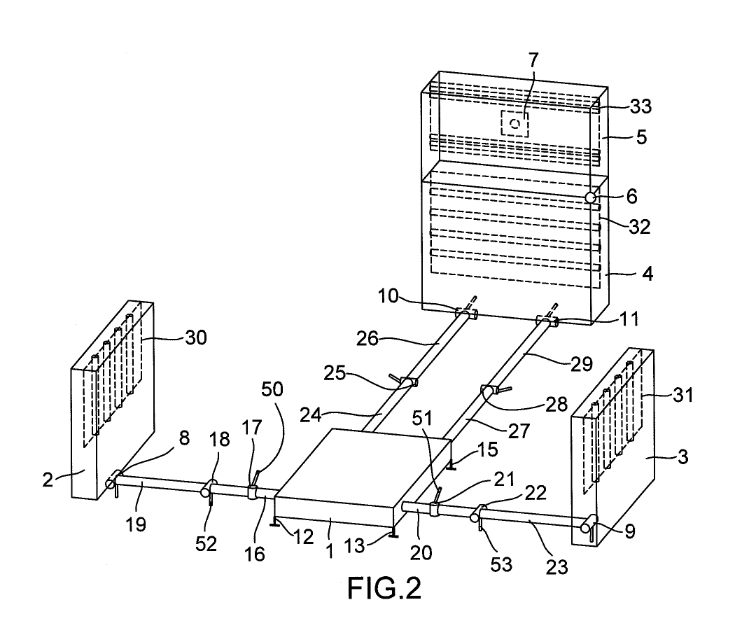

FIG. 2 shows the expanded status of an extendable light box according to one embodiment of this invention, which is shown as a wide-open type of photography system. A slide guide 16, horizontal joint 17, vertical joint 18, connecting rod 19 and vertical joint 8 are structured and used to connect the photography platform 1 and the left lamphousing 2. The left lamphousing 2 can be moved away from the photography platform 1 by using the slide guide 16, and horizontally rotated and vertically folded by using the horizontal joint 17 and the vertical joint 18 respectively, and can be vertically rotated by using the combination of the connecting rod 19 and vertical joint 8. By the same way, the structured slide guide 20, horizontal joint 21, vertical joint 22, connecting rod 23 and vertical joint 9 are used to connect the photography platform 1 and the right lamphousing 3. The structured mechanism of slide guide 24, vertical joint 25, connecting rod 26 and vertical joint 10 and the structured mechanism of slide guide 27, vertical joint 28, connecting rod 29 and vertical joint 11 are used to connect the left bottom of the back lamphousing 4 and the right bottom of the back lamphousing 4 respectively. Also, horizontal joints can be configured between slide guide 24 and vertical joint 25 and between slide guide 27 and vertical joint 28 respectively. A top lamphousing 5 is configured on the top of back lamphousing 4 by using a vertical joint 6, and the camera housing 7 is arranged on the top lamphousing 5. Lighting sources 30, 31, 32 and 33 are respectively configured in left lamphousing 2, right lamphousing 3, back lamphousing 4 and top lamphousing 5. Above-mentioned slide guides 16, 20, 24 and 27 all can be equipped with at least one horizontal joint and/or vertical joint.

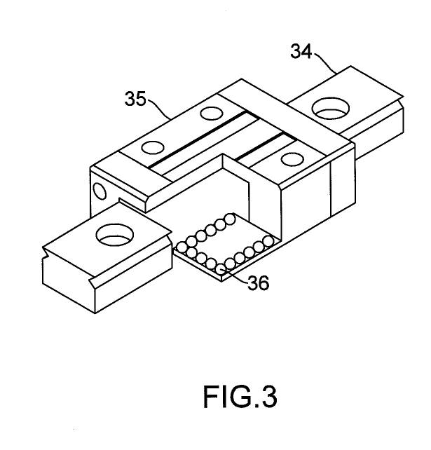

FIG. 3 shows the structure of a slide guide of an extendable light box according to one embodiment of this invention. Each of slide guides 16, 20, 24 and 27 is structured by rail 34, sliding block 35 and bearing 36.

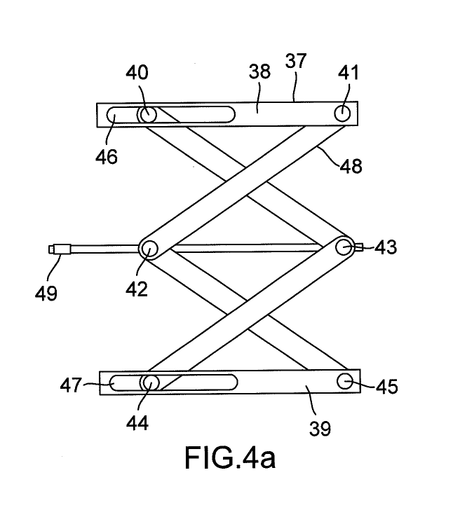

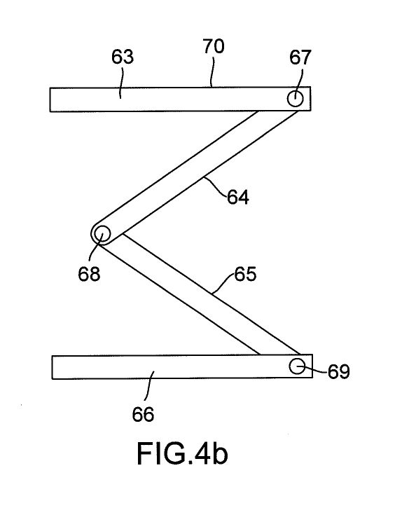

FIG. 4a and FIG. 4b show the side view of a shearing-type extending unit of an extendable light box according to one embodiment of this invention. Other than the slide guides 16, 20, 24 and 27, a dual shearing-type extending unit 37 that shown as FIG. 4a, or a single shearing-type extending unit 70, shown as FIG. 4b, can also be used as the sliding/extending mechanism. Dual shearing-type extending unit 37 comprises top platform 38, bottom platform 39, rotation shafts 40, 41, 42, 43, 44 and 45, sliding slots 46 and 47, fixing plate 48 and front end 49. The dual shearing-type extending unit 37 can be driven by turning the front end 49 with a wrench, and then the lamphousings can be moved away from or to the photography platform 1. The single shearing-type extending unit 70, shown as FIG. 4b, comprises fixing plates 63, 64, 65 and 66, rotation shafts 67, 68 and 69, and can be expanded or collapsed by directly pulling the fixing plate 63. Further, at least one horizontal and vertical joint can be configured on the dual shearing-type extending unit 37 or the single shearing-type extending unit 70.

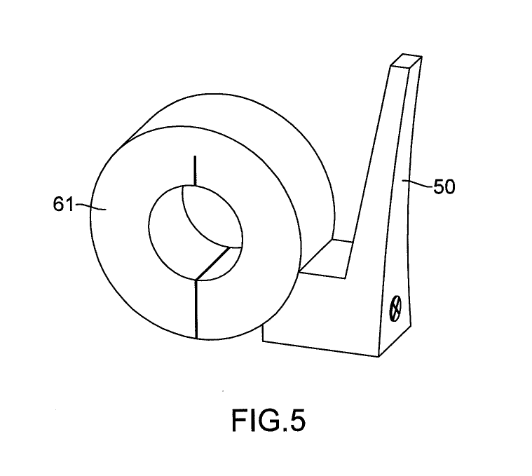

FIG. 5 shows a horizontal joint applied to an extendable light box according to one embodiment of this invention. A clamp lever 50 is used on a set collar-slit type 61 to form a horizontal joint, which can be used to the embodiment shown in FIG. 2. The left lamphousing 2 and right lamphousing 3 can be horizontally rotated when clamp levers 50 and 51 are loosened.

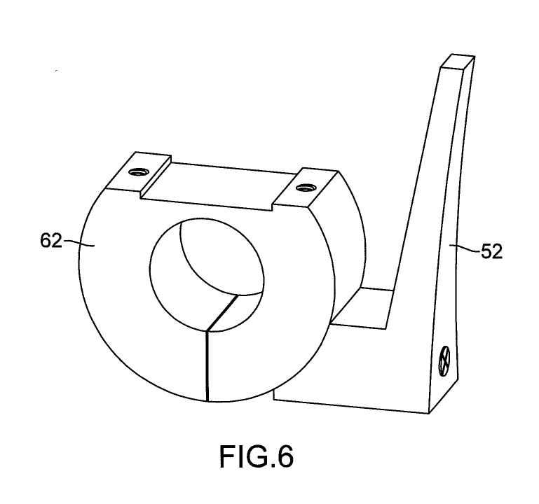

FIG. 6 shows a vertical joint used to an extendable light box according to one embodiment of this invention. A clamp lever 52 is used on the set collar-type D cut type 62 to form a vertical joint, which can be applied to the embodiment shown in FIG. 2. The left lamphousing 2 and right lamphousing 3 can be vertical folded when clamp levers 52 and 53 are loosened.

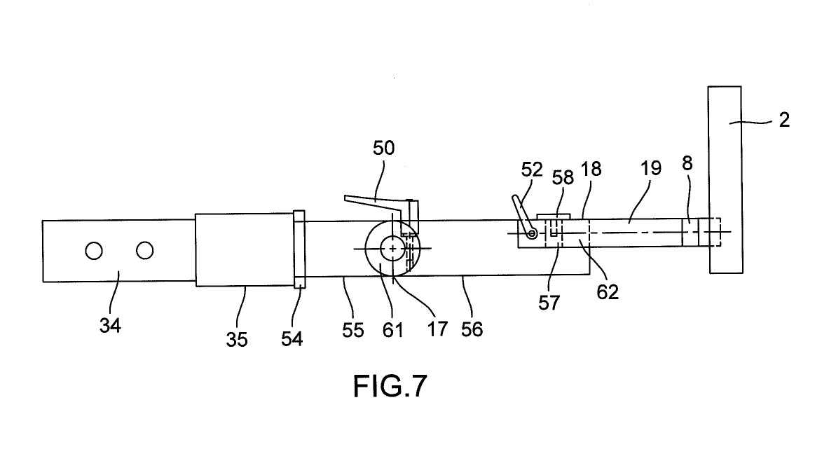

FIG. 7 shows the integration of slide guide, horizontal rotation (horizontal joint) and vertical folding (vertical joint) mechanism. The sliding block 35 can be moved along rail 34 and a stopper 54 is configured at the end to prevent the sliding block 35 from falling off in sliding. One end of an extending rod 55 is connected to the sliding block 35 and the other end to the horizontal joint 17. One end of the extending rod 56 is connected to the horizontal joint 17, and the other end is configured with a rotating shaft 57, which passes through the center hole of the vertical joint 18 and is locked by a cap 58 to prevent the lamphousing from falling off in folding.

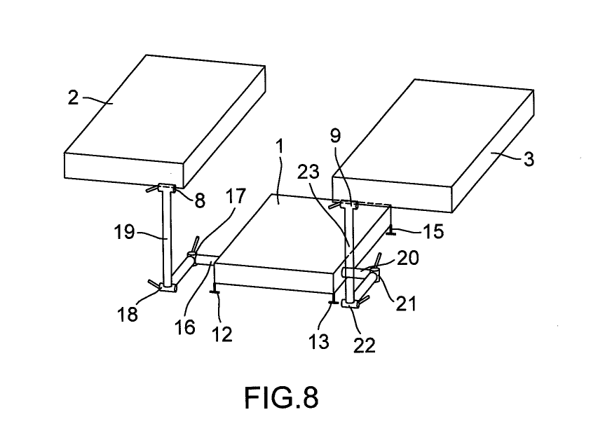

FIG. 8 shows the status of the left and right lamphousing expanding from the photography platform of an extendable light box according to one embodiment according to this invention. The slide guide 16 is pulled out from the bottom of the photography platform 1, the horizontal joint 17 is rotated forward and the vertical joint 18 is folded upward, and as a result, the left lamphousing 2 is driven to the upper left front of the photography platform 1. By the same way, the slide guide 20 is pulled out from the bottom of the photography platform 1, the horizontal joint 21 is rotated forward and the vertical joint 22 is folded upward, and as a result, the right lamphousing 3 is driven to the upper right front of the photography platform 1. The lighting directions of the lamphousings 2 and 3 can be adjusted by rotating the vertical joints 8 and 9.

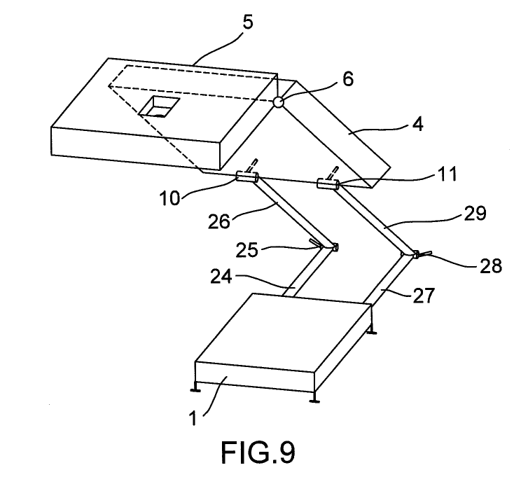

FIG. 9 shows the status of the back lamphousing 4 expanding from the photography platform 1 of an extendable light box according to one embodiment according to this invention. The slide guides 24 and 27 are pulled out from the photography platform 1 and the vertical joints 25 and 28 are rotated upward to drive the back lamphousing 4 to upper rear of the photography platform 1. Accompanying with adjustments of the vertical joints 10, 11 and 6, the top lamphousing 5 configured on the back lamphousing 4 can be moved to the upper of the photography platform 1 and/or adjusted to the intended lighting direction.

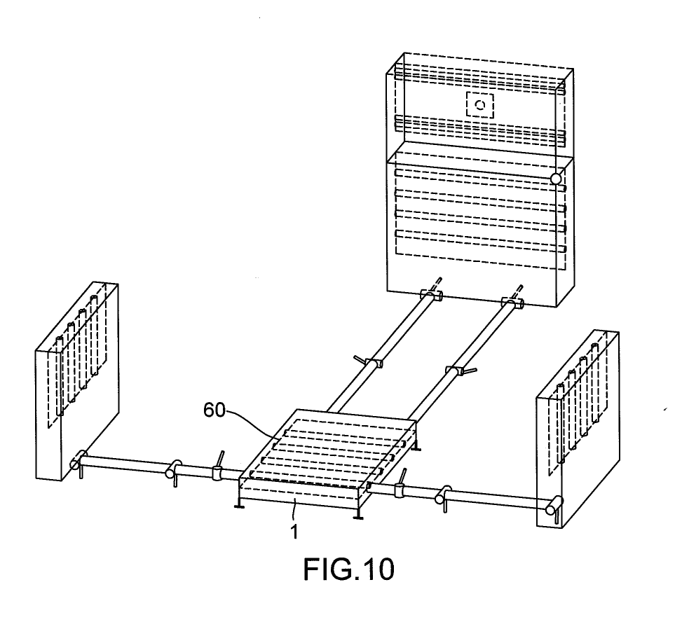

FIG. 10 shows the expanded status of an extendable light box according to one embodiment of this invention, and the photography platform 1 is also designed as a lamphousing. Similar with the embodiment shown as FIG. 2, the photography platform 1 of the embodiment, shown as FIG. 10, is embedded by lighting source 60 to be a lamphousing, which makes a shadow free photographing become possible.

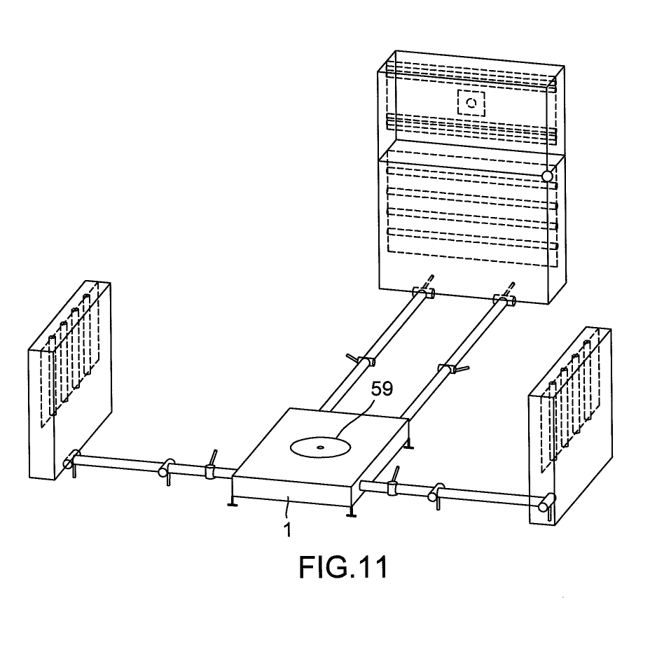

FIG. 11 shows the expanded status of an extendable light box according to one embodiment of this invention, and the photography platform 1 is embedded by a turntable for rotating a photographed object. Similar with the embodiment shown as FIG. 2, the photography platform 1 of the embodiment, shown as FIG. 11, is embedded by a turntable 59, which is convenient to shoot the photographed object from different angles.

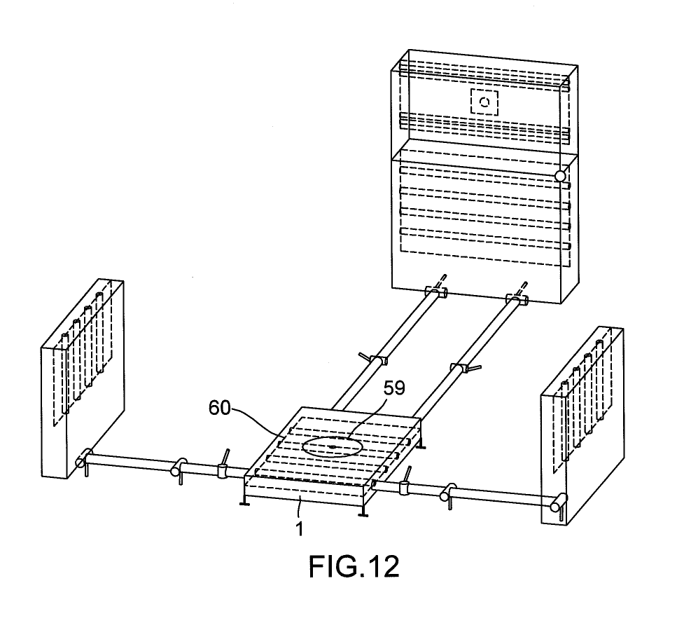

FIG. 12 shows the expanded status of an extendable light box according to one embodiment of this invention, and the photography platform 1 is designed as a lamphousing and embedded by a turntable. Similar with the embodiment shown as FIG. 2, a turntable 59 and a lighting source 60 are embedded into the photography platform 1 for rotating the photographed object and make a shadow free photographing become possible.

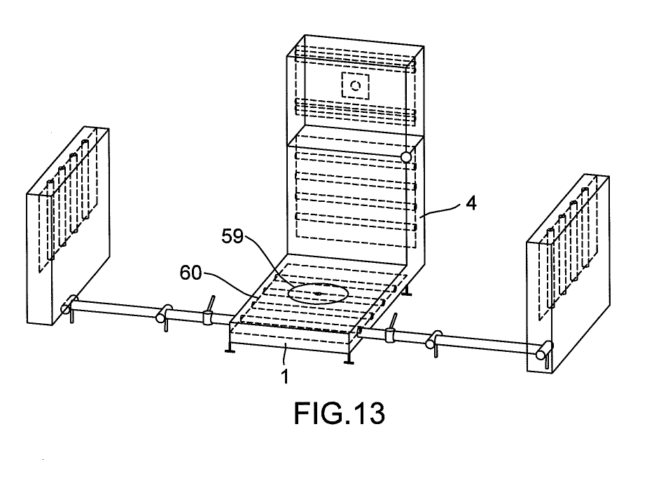

FIG. 13 shows an extendable light box according to one embodiment of this invention, where the photography platform 1 and the back lamphousing 4 are perpendicularly combined into one unit. The photography platform 1 is embedded by a lighting source 60 and/or a turntable 59, same as the embodiment shown as FIG. 12. Similar with the embodiment shown as FIG. 2, a turntable 59 and lighting source 60 are embedded into the photography platform 1 for rotating the photographed object and make a shadow free photographing become possible. The sliding/extending mechanisms are used to connect the photography platform 1 to the left lamphousing 2 and right lamphousing 3 respectively, such as the slide guide or dual/single shearing-type extending unit. Same as mentioned above, at least one horizontal joint and/or vertical joint can be arranged on the sliding/extending mechanism and all the connections are exactly same as the embodiment shown FIG. 2, and a camera housing 7 is also arranged on the top lamphousing 5.

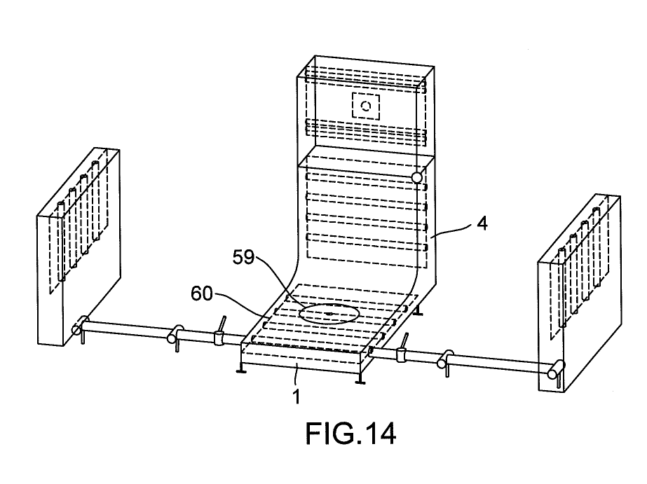

FIG. 14 shows an extendable light box according to one embodiment of this invention, which is similar with the embodiment shown in FIG. 13, but the photography platform 1 and the back lamphousing 4 are roundly combined into one unit. The photography platform 1 is embedded by a lighting source 60 and/or a turntable 59. Similar with the embodiment shown as FIG. 2, a turntable 59 and lighting source 60 are embedded into the photography platform 1 for rotating the photographed object and make a shadow free photographing become possible. The sliding/extending mechanisms are used to connect the photography platform 1 to the left lamphousing 2 and right lamphousing 3 respectively, such as the slide guide or dual/single shearing-type extending unit. Same as mentioned above, at least one horizontal joint and/or vertical joint can be arranged on the sliding/extending mechanism and all the connections are exactly same as the embodiment shown FIG. 2, and a camera housing 7 is also arranged on the top lamphousing 5.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An extendable light box comprising:
a photography platform;
a left lamphousing connected to the photography platform with a first sliding/extending mechanism;
a right lamphousing connected to the photography platform with a second sliding/extending mechanism; and
a back lamphousing connected to the photography platform with a third sliding/extending mechanism.

2. An extendable light box according to claim 1, wherein the first, second and third sliding/extending mechanism are implemented by a slide guide or a shearing-type extending unit.

3. An extendable light box according to claim 2, wherein at least one horizontal joint and vertical joint on the slide guide or the shearing-type extending unit.

4. An extendable light box according to claim 1, further comprising a top lamphousing connected on the top of the back lamphousing with a rotation mechanism.

5. An extendable light box according to claim 4, wherein a camera housing is arranged on the top lamphousing.

6. An extendable light box according to claim 1, further comprising a turntable embedded into the photography platform.

7. An extendable light box comprising:
a photography platform and a back lamphousing are combined into a unit;
a left lamphousing connected to the photography platform with a first sliding/extending mechanism; and
a right lamphousing connected to the photography platform with a second sliding/extending mechanism.

8. An extendable light box according to claim 7, wherein the photography platform is perpendicularly or roundly combined with the back lamphousing to be one unit.

9. An extendable light box according to claim 7, further comprising a top lamphousing connected on the top of the back lamphousing with a rotation mechanism.

10. An extendable light box according to claim 9, wherein a camera housing is arranged on the top lamphousing.

11. An extendable light box according to claim 7, wherein the first and second sliding/extending mechanism are implemented by a slide guide or a shearing-type extending unit.

12. An extendable light box according to claim 11, wherein at least one horizontal joint and vertical joint on the slide guide or the shearing-type extending unit.

13. An extendable light box according to claim 7, further comprising a turntable embedded into the photography platform.
